(19) United States
(12) Patent Application Publication
(10) Pub. No.: US 2024/0393423 A1
(43) Pub. Date: Nov. 28, 2024

(54) SYSTEM AND METHOD FOR GUIDING A VEHICLE FOR RIDE-SHARING OR CHARGING

(71) Applicants: Denso International America, Inc., Southfield, MI (US); Denso Corporation, Kariya-city (JP)

(72) Inventors: Tirthesh SHAH, Canton, MI (US); Jagadeesh Krishnamurthy, Frisco, TX (US)

(73) Assignees: Denso International America, Inc., Southfield, MI (US); Denso Corporation, Kariya-city (JP)

(21) Appl. No.: 18/591,100

(22) Filed: Feb. 29, 2024

Related U.S. Application Data
(60) Provisional application No. 63/504,573, filed on May 26, 2023.

(51) Int. Cl. G01S 5/14; B60L 53/12; B60L 53/36; B60W 60/00; H02J 50/40; H02J 50/80; H02J 50/90

(52) U.S. Cl. CPC G01S 5/14; B60W 60/0025; H02J 50/80; H02J 50/90; B60L 53/12; B60L 53/36; H02J 50/40

(57) ABSTRACT

A method and system for positioning a vehicle includes determining a first distance between a beacon transmitter and the vehicle. The method further includes communicating an initiation signal to the beacon transmitter when the first distance is less than a distance threshold, generating a beacon signal at the beacon transmitter in response to the initiation signal, receiving the beacon signal at a mobile receiver, and generating a direction signal in a controller of the vehicle to achieve a desired position relative to the beacon transmitter.

### CROSS-REFERENCE TO RELATED APPLICATION

This application claims the benefit of U.S. Provisional Application No. 63/504,573 filed on May 26, 2023. The entire disclosure of the above application is incorporated herein by reference.

### TECHNICAL FIELD

The present disclosure relates to a vehicle guidance system, and, more particularly, to a system for guiding a vehicle to a vehicle charger or to a new ride-sharing occupant.

### BACKGROUND

This section provides background information related to the present disclosure which is not necessarily prior art.

Electric powered vehicles are increasing becoming popular. Electric powered vehicles typically require a hard wire to charge them. The hard wire is plugged into a charger and a connector is coupled to the vehicle through which the electricity is used to charge the battery. Another way to charge a vehicle is by wireless charging. Currently, wireless charging is used for certain mobile phones and devices. However, wireless charging has not been widely adopted to charge a vehicle.

Wireless charging of a vehicle uses a transmitter at a charging pad that is spaced apart from a receiver located on the vehicle. A magnetic field is generated at the transmitter which causes a current to flow at the receiver which is directed to charge the battery. One issue with wireless chargers is the alignment of the transmitter and receiver. If the transmitter and receiver are not precisely aligned, the amount of current induced for charging the battery within the vehicle is reduced.

Another technology that has become popular over the last several years is ride sharing of the vehicle. Ride sharing allows one vehicle and pick up another occupant. The occupants may be located on a sidewalk or nearby. The vehicle needs to be directed to a location near the additional occupants so that the additional occupant can enter the vehicle.

### SUMMARY

This section provides a general summary of the disclosure and is not a comprehensive disclosure of its full scope or all of its features.

The present system provides a system and method for guiding a vehicle for ridesharing or wirelessly charging. The system combines macro location to locate and direct the vehicle to within a close proximity of a ride sharing user or charging pad and micro location to more accurately direct the vehicle once within the close proximity.

In one aspect of the disclosure, a method for positioning a vehicle includes determining a first distance between a beacon transmitter and the vehicle. The method further includes communicating an initiation signal to the beacon transmitter when the first distance is less than a distance threshold, generating a beacon signal at the beacon transmitter in response to the initiation signal, receiving the beacon signal at a mobile receiver, and generating a direction signal in a controller of the vehicle to achieve a desired position relative to the beacon transmitter.

In another aspect of the disclosure, a system includes a beacon transmitter, a vehicle comprising a mobile receiver, a controller is coupled to the receiver and determines a first distance between a beacon transmitter and the vehicle. When the first distance is less than a distance threshold, the controller communicates an initiation signal to the beacon transmitter. The beacon transmitter generates a beacon signal in response to the initiation signal. The mobile receiver receives the beacon signal. The controller generates a direction signal to achieve a desired position relative to the beacon transmitter.

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations and are not intended to limit the scope of the present disclosure.

FIG. 1 is a high-level block diagrammatic view of the system for controlling the vehicle.

FIG. 2 is a diagrammatic view of a vehicle aligned with a charging pad.

FIG. 3 is a vehicle aligned with a mobile device for ride sharing.

FIG. 4 is a block diagrammatic view of the vehicle.

FIG. 5 is a block diagrammatic view of the beacon controller.

FIG. 6 is a block diagrammatic view of the beacon controller coupled to a plurality of receivers and transmitters.

FIG. 7 is a block diagrammatic view of a central controller.

FIG. 8 is a block diagrammatic view of a mobile device.

FIG. 9 is a top view of a charging pad relative to a vehicle receiver.

FIG. 10A is a first example of a screen display for directing a vehicle operator.

FIG. 10B is a second example of a screen display for directing a vehicle operator.

FIG. 10C is a third example of a screen display for directing a vehicle operator.

FIG. 10D is a fourth example of a screen display for directing a vehicle operator.

FIG. 11 is a flowchart of a method for aligning a vehicle with a charging pad.

FIG. 12 is a flowchart of a method for directing the vehicle to a ride share requester.

Corresponding reference numerals indicate corresponding parts throughout the several views of the drawings.

### DETAILED DESCRIPTION

Example embodiments will now be described more fully with reference to the accompanying drawings.

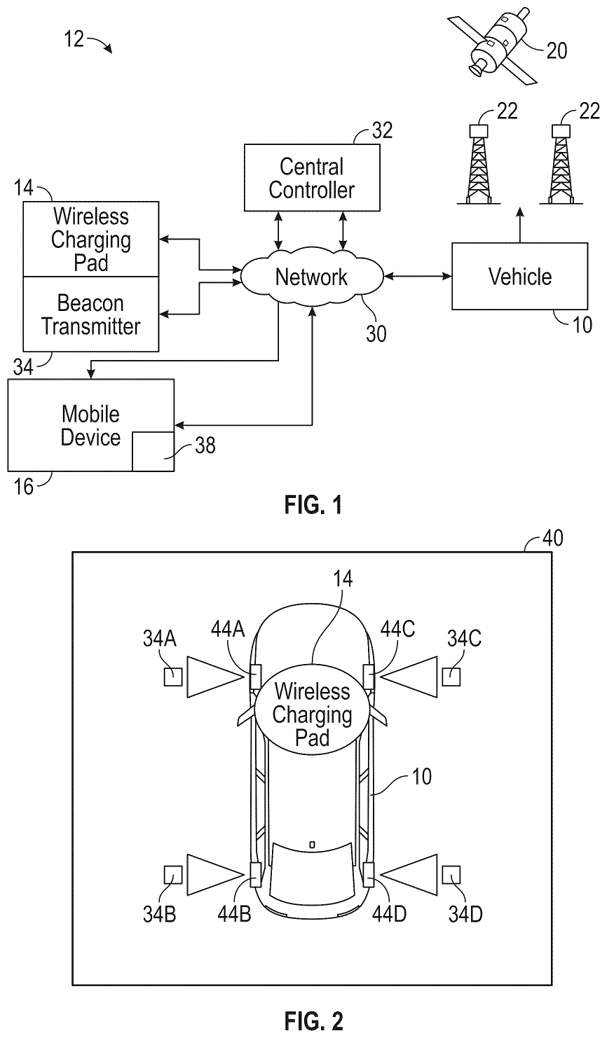

Referring now to FIG. 1, a vehicle 10 is illustrated as part of a system for guiding the vehicle 10 to a location. The vehicle 10 is illustrated as a passenger vehicle, such as a car. However, other types of vehicles, including trucks, sport utility vehicles, recreational vehicles and marine vessels are contemplated. In this example, the end location is a wireless charging pad 14 or a mobile device 16 that is being used by a user that wants to be occupant of the vehicle for ride sharing. For wireless charging, alignment of the vehicle charging receiver to the wireless charging transmitter allows higher charging efficiency. For ride-sharing the location technique reduces the likelihood of picking up the wrong passenger. The vehicle 10 may determine a macro-location by a GPS system represented by a satellite 20. The macro-location of the vehicle 10 may also be determined by triangulation techniques from ground base cellular towers 22. Macro-location is a location such as GPS is typically accurate to about 16 feet. Micro-location is used below to more accurately position the vehicle relative to a charging pad or a ride-sharing user. Micro-location, as set forth herein, has been found to be accurate within one centimeter.

The vehicle 10 communicates through a network 30. The vehicle 10 may communicate with a central controller 32 through the network 30. The vehicle 10 may also communicate with the charging pad 14, a beacon transmitter 34 and a mobile device 16 through the network 30. In general, the mobile device 16 may also have a beacon transmitter 38. The beacon transmitters 34, 38 are described in greater detail below. In general, the beacon transmitters 34, 38 generate beacon signals that are used to micro-locate the vehicle 10 when the vehicle 10 is within a certain proximity or boundary to the charge pad 14 or the mobile device 16. The boundary acts as a distance threshold between macro and micro-location techniques. The vehicle 10 may communicate to the charge pad 14, the beacon transmitter 34, the mobile device 16 and the beacon transmitter 38 through the central controller 32 or directly through the network 30 depending upon the desired operation of the system.

Referring now to FIG. 2, the vehicle 10 is illustrated at the charging pad 14. In this example, a plurality of beacon transmitters 34A-34D are disposed around the vehicle 10 and around the charging pad 14. A boundary 40 is illustrated around the vehicle 10 and the beacon transmitters 34. The boundary 40 indicates the boundary to which the vehicle 10 is switched from macro-location to micro-location. The boundary 40 may be set based on the distance the transmitters 34A-34D transmit so receivers 44A-44D may accurately receive and the system can determine the micro-location of the vehicle 10. That is, the vehicle 10 may be macro-located by GPS autonomous or by the vehicle operator outside and up to the boundary 40. Within the boundary 40, micro-location may be used to more accurately direct the vehicle autonomously or instruct the vehicle operator manually with instructions to locate the vehicle 10 at the wireless charging pad 14. As mentioned briefly above, accurately aligning the vehicle 10 to achieve a desired position relative to the charging pad 14 is important to provide the most efficient charging. In this example, four receivers 44A, 44B, 44C and 44D are used for receiving the signals from the transmitters 34A-34D located around the charging pad. The transmitters 34A-34D may use Bluetooth® low energy (BLE), high accuracy distance measurement (HADM) for determining a distance between the transmitters 34A-34D and the receivers 44A-44D, as will be described in greater detail below. Ultimately, the location of the vehicle 10 may be controlled so that the vehicle 10 aligns in a desired location relative to the wireless charging pad 14.

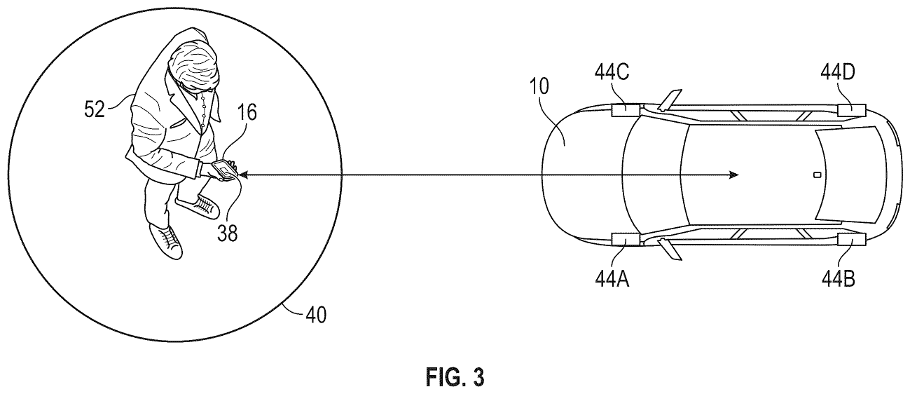

Referring now to FIG. 3, a ride sharing system in which the mobile device 16 has an application (app) for requesting the vehicle 10 for ride sharing is set forth. The vehicle 10 has the receivers 44A-44D as described above. When the vehicle 10 is located within the boundary 40′, autonomous driving or direction signals are provided to the vehicle operator to locate the ride share person 52 that is holding the mobile device 16 with the transmitter 38 therein. The boundary 40′ may be positioned so that within the boundary 40′ the transmitter 38 has enough power so the receivers 44A-44D can determine the distance.

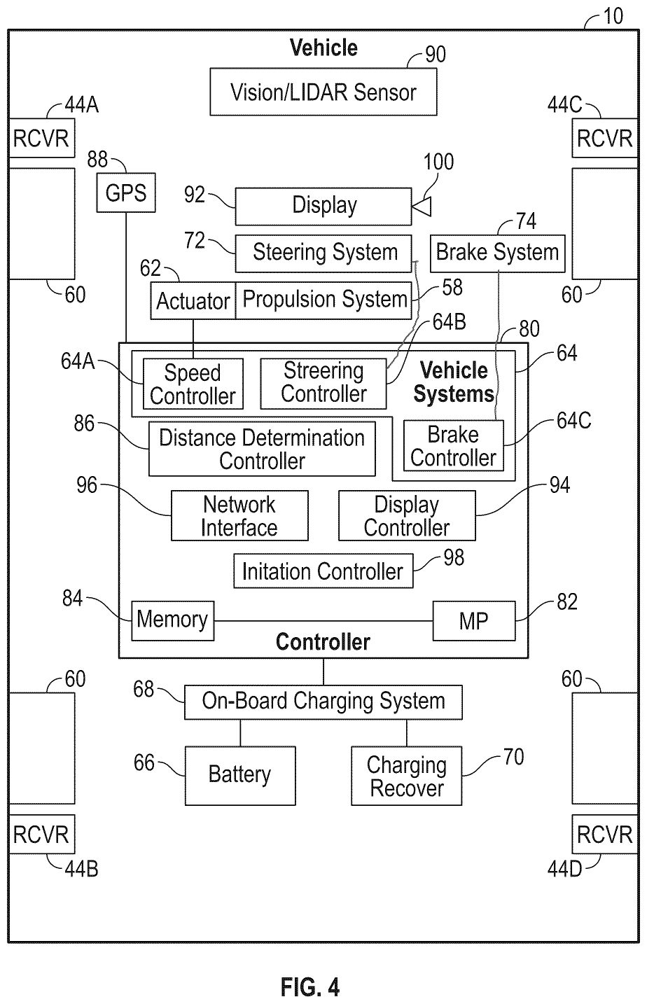

Referring now to FIG. 4, the vehicle 10 and the components therein are illustrated in further detail. The vehicle 10 has a propulsion system 58 that is used to provide power to the wheels 60 of the vehicle 10. The propulsion system 58 is illustrated simply but may represent various types of propulsion systems including internal combustion, hydrogen, battery electric and hybrid vehicles. Depending on the type of system, different ways for coupling the wheels 60 to the propulsion system 58 may be provided. The propulsion system 58, for example, may be coupled to all the wheels 60 or less than all the wheels 60. An actuator 62, such as a mechanical or electric throttle, receives an input to control the propulsion system 58 from the vehicle operator or from the vehicle system 64.

The vehicle 10 includes a battery 66 that has a plurality of cells located within a battery housing. The battery 66 may be a battery large enough to propel a hybrid, electric vehicle, or provide electrical functions in an internal combustion engine environment. The battery 66 is coupled to an on-board charging system 68. The on-board charging system 68 is used to control the charging of the battery 66. In particular, the charging rate may be changed depending upon the input to the on-board charging system 68. One input is a charging receiver 70 that is part of the wireless charging pad 14 illustrated in FIG. 1. The charging receiver 70 has induced current from a transmitter of the charging pad to control the wireless charging of the battery 66.

The vehicle 10 may also include a steering system 72 that is used for steering one or more of the wheels 60. In many vehicles, the front wheels 60 are steered. In other vehicles, all four wheels 60 may be steered. A braking system 74 is also coupled to each of the wheels 60 for slowing the operation of the vehicle 10. The braking system 74 may be friction braking system using conventional brake pads. However, the braking system 74 may be a regenerative braking system in a hybrid electric or pure electric vehicle.

A controller 80 is disposed within the vehicle. The controller 80 includes a processor 82 and a memory 84. Although only one memory 84 is illustrated, multiple memories may be used within the controller 80. The memory 84 may be a non-transitory memory that is programmed to perform the various functions as described in greater detail below. The microprocessor or processor 82 may comprise one or more microprocessors that act together to perform the various functions and control the various functional aspects of the vehicle 10.

The controller 80 may include the vehicle systems 64. The vehicle systems 64 may be autonomous vehicle systems. The vehicle systems 64 may also be controlled by the vehicle operator. The vehicle systems 64 may include a speed controller 64A, a steering controller 64B and a brake controller 64C with direction signals to achieve the desired location. The speed controller 64A controls the speed of the vehicle by controlling the propulsion system 58 and/or the actuator 62. As mentioned above, the actuator 62 may be a throttle that is electronically controlled by the speed controller 64A. The steering controller 64B may control the direction of one or more of the wheels 60 in the vehicle. As mentioned above, the front wheels, the rear wheels, or a combination of all the wheels 60 may be steered into the desired direction. The steering controller 64B may control the steering system 72 in a steer-by-wire fashion.

The brake controller 64C controls the braking system 74 to apply brakes to slow the vehicle. In an internal combustion engine vehicle, the brake controller 64C may control the application of brake pads to rotors at the wheels 60. In a hybrid or electric vehicle, the braking system 74 may be combination of friction braking and regenerative braking.

The controller 80 may also include a distance determination controller 86. The distant determination controller 86 may determine a distance between the vehicle and the mobile device or wireless charging pad using macro-locating techniques and micro-location techniques. That is, outside the boundary 40, 40′ cellular triangulation and GPS may be used to determine where the vehicle is located relative to the boundary. Once within the boundary 40, 40′ micro-locating techniques may be used to direct the vehicle 10 to the wireless charging pad 14, or to the mobile device 16.

The distance determination controller 86 may be in communication with the receivers 44A-44D. By knowing the distance to the transmitter or transmitters, the location of the vehicle 10 may be determined using micro-location so that a predetermined position of the vehicle may be achieved. That is, triangulation techniques may be used to determine the exact location of the vehicle 10. The distance determination controller 86 may more accurately determine the location of the vehicle in a more accurate fashion than that of the global positioning system 88. As mentioned above, the distance determination controller 86 may also be in communication with the global positioning system 88 to provide a micro-location determination as to the position of the vehicle. As the vehicle approaches the boundaries 40 or 40′, the vehicle may use the distance determination controller 86 and the signals received by the receivers 44A-44D from the transmitters 34A-34D to triangulate the precise precision of the vehicle. By way of example, the distance from each transmitter may be determined at each receiver. The distances determined are used to determine the precise location of the vehicle and therefore the location of the wireless charging receiver relative to the wireless charging transmitter. The ultimate goal is to obtain a predetermined position for the vehicle. In the case of wireless charging, alignment of the charging transmitter to the charging receiver within a centimeter may be the goal. In a ride sharing system, the predetermined position may be within a meter of the ride sharing user and the mobile device with the ride sharing application.

The vehicle 10 also includes sensors 90 that are used to guide the vehicle and provide safety aspects. The sensors 90 may include, but are not limited to vision, radar, lidar and combinations thereof. Inputs from the one or more sensors 90 are used by the vehicle systems 64 to prevent collisions.

A display 92 is used for displaying various types of data, climate control, entertainment, guidance and other functions of the vehicle. The display 92 in this application may display instructions for directing the vehicle in the desired direction. A display controller 94 is in communication with the display 92. The display controller 94 may receive direction signals or control commands from the vehicle systems to direct the vehicle in the desired direction. That is, the vehicle systems 64A-64C may act in a non-autonomous manner to provide instructions for the vehicle operator to direct the vehicle into the desired location based on the control commands. A visual display may be used. However, voice control commands as audible signals generated from a speaker 100 may be used together with or instead of the visual display.

A network interface 96 is used to communicate to the central controller 32, the wireless charging pad 14, to the beacon controller 34 or to the mobile device 16.

An initiation controller 98 is used to initiate or send an activation control signal to the transmitter or transmitters to initiate transmitting of the continuous tone signal. The initiation controller 98 of the controller 80 may generate the control signal and communicate the control signal through the network interface 96 and the network 30 to the beacon transmitters 34, 38 so micro-location can be used.

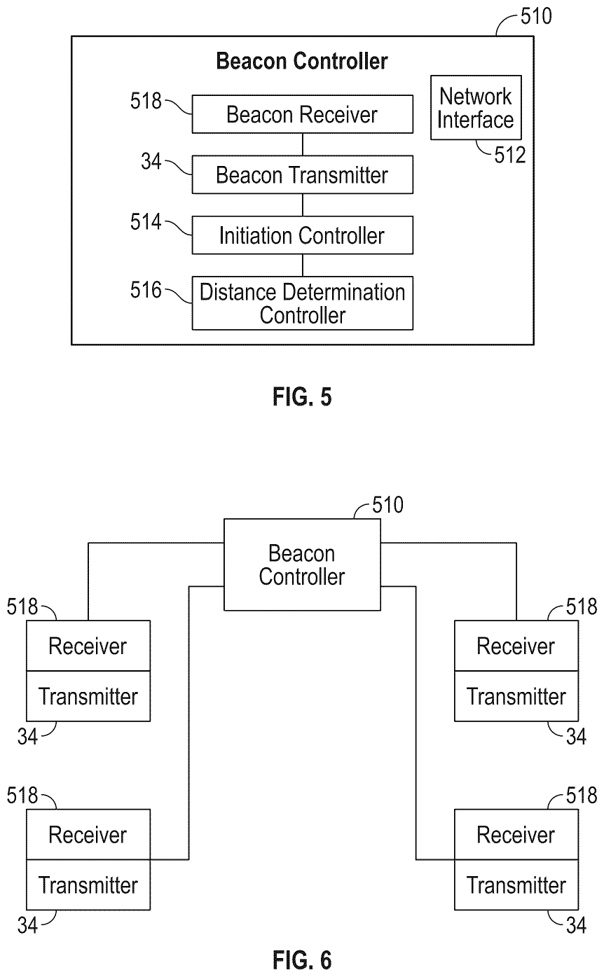

Referring now to FIG. 5, a block diagrammatic view of a beacon controller 510 is illustrated. The beacon controller 510 may include a network interface 512 that is used to communicate with the network 30 to receive various control signals. The beacon controller 510 may control the beacon transmitter 34. An initiation controller 514 may receive control commands from the network interface 512 that a vehicle 10 is within the boundary and therefore initiates through the initiation controller 514 the transmission of the beacon from the beacon transmitter 34. A distance determination controller 516 may receive the position of the vehicle 10. That is, the position of the beacon controller 510 may be known or fixed. The vehicle 10 may communicate the global positioning system coordinates from the global positioning system 88 through the network interface 96 and through the network interface 512 so that the distance determination controller 516 may determine the distance to the vehicle 10. When the vehicle 10 is within the boundary 40, the initiation controller 514 may activate the beacon transmitter 34 to generate the one or more beacon signals at the beacon transmitters.

The beacon transmitters 34 may also be associated with a beacon receiver 518 should two-way communication be desired. The beacon receiver 518 may receive signals from the vehicle 10 and from the transceivers 44A-44D.

Referring now to FIG. 6, the beacon controller 510 may be in communication with the beacon transmitters 34 and the beacon receivers 518. FIG. 6 corresponds generally to a system having various beacon transmitters and receivers. Although four transmitters 34 and four receivers 518 are illustrated, fewer or greater number of receivers and transmitters may be used in a system. The beacon controller 510 may control the operation of the transmitters 34 and the receivers 518 based upon the distance controller 516. However, the central controller 32 or the vehicle 10 may communicate directly with the beacon controller 510 to provide a control signal so that initiation of the beacon transmitter 34 may be performed. That is, the control signal received through the network interface 512 may initiate the operation of or turn on the beacon transmitter 34.

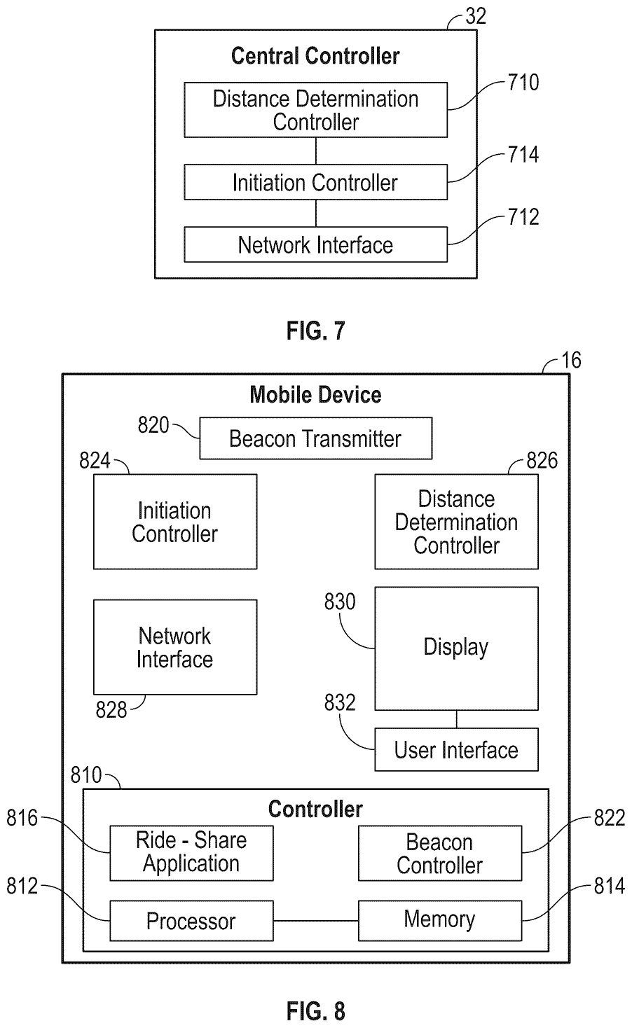

Referring now to FIG. 7, the central controller 32 is illustrated in further detail. The central controller 32 may include a distance determination controller 710. The distance determination controller 710 may obtain the position of the beacon controller 510 and/or the various transmitters 34 associated therewith as well as the global position of the vehicle 10. The central controller 32 may receive the signals through a network interface 712 from the vehicle 10 and the beacon controller 510. An initiation controller 714 may act in a similar manner to that described above with respect to the initiation controller 98, 514. The initiation controller 714 may initiate the generation of the beacon signals from the one or more beacon transmitters.

Referring now to FIG. 8, a high-level block diagrammatic view of the mobile device 16 is illustrated. The mobile device 16 includes a controller 810 that has a processor 812 coupled to a non-transitory memory 814 that is programmed to allow the processor 812 to perform various functions period. The controller 810 may have a ride sharing application 816 stored therein. The ride sharing application 816 may be stored directly within the memory 814. The mobile device 16 may include a beacon transmitter 820 disposed therein. The beacon transmitter 820 may be activated by a beacon controller 822 disposed within the controller 810. The beacon controller 822 may activate the beacon transmitter 820 in a similar manner to the beacon transmitters described above. That is, an initiation controller 824 may be used to initiate the operator of the beacon transmitter 820. A distance determination controller 826 may generate a signal as to the position or location of the mobile device 16. The distance determination controller 826 may be generated from a global positioning system or triangulation of cell towers in a cellular system. The location determined by the distance determination controller 826 may be communicated through the network 30 to the vehicle 10 and/or the central controller 32 through a network interface 828.

The mobile device 16 may include a display 830 that is used to display various information and data including information and data corresponding to the ride share application. A user interface 832 such as push button or plurality of push buttons or a touch screen as used to enter data into the mobile device 16. The user interface 832 may be used to initiate a ride share and provide various passwords and desired destinations for the ride share.

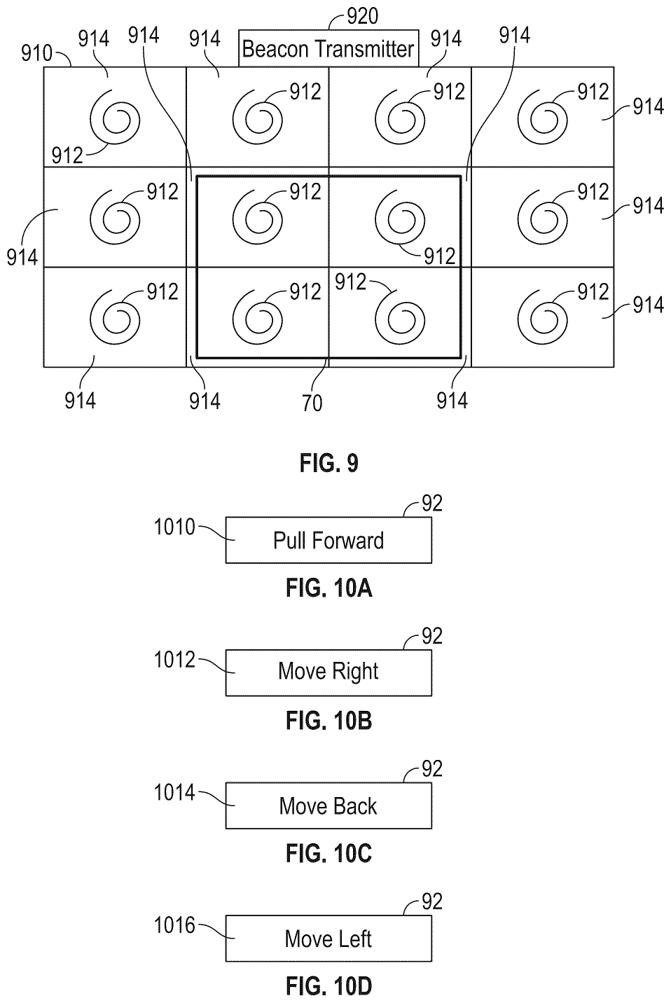

Referring now to FIG. 9, one example of a wireless charging pad 910 is set forth. In this example, the wireless charging pad 910 has a plurality of transmitter elements 912. The system may direct the charging receiver 70 to be directed over specific elements of the wireless charging pad 910. In this example, the charging receiver 70 corresponds to the size of four of the transmitter elements 914. As mentioned above, the charging receiver 70 may be various sizes depending upon the vehicle. For example, a larger vehicle may use a greater number of elements 914. The micro-location capabilities of the present disclosure allow precise location of the charging receiver 70 relative to the elements 914. As mentioned above, the predetermined position of less than 1 centimeter may be determined and achieved.

The wireless charging pad 910 may also include a beacon transmitter 920. The beacon transmitter 920 may be a single beacon transmitter used to guide the vehicle 10 into the desired location.

Referring now to FIGS. 10A-10D, various examples of a screen display providing directions to the vehicle operator are set forth. In this example, FIG. 10A shows a pull forward message 1010. FIG. 10B shows a move right message 1012. FIG. 10C shows a move back message 1014. FIG. 10D shows a move left message 1016. Each of the messages may be displayed within the vehicle and are communicated from the display controller 94 to the display 92. Of course, various other messages may be generated.

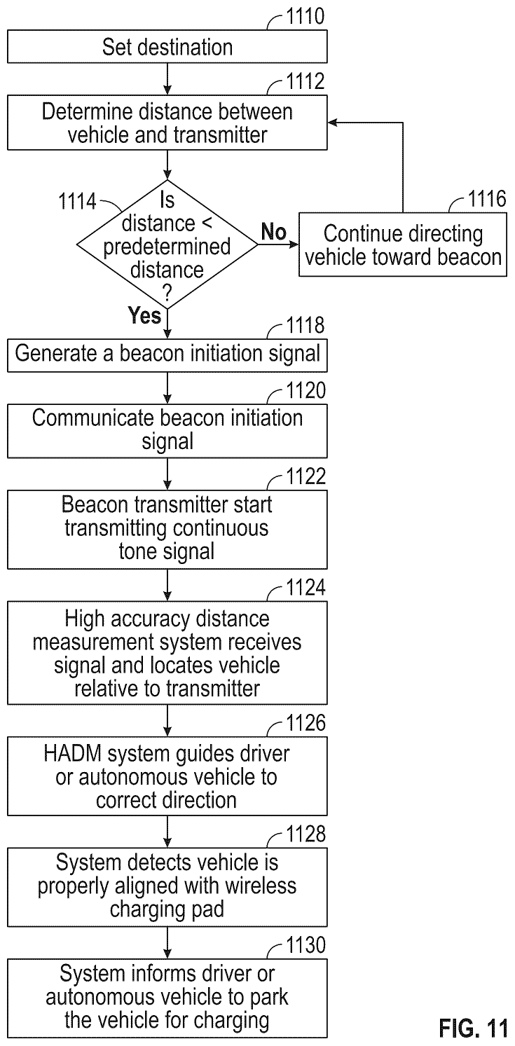

Referring now to FIG. 11, a method for directing the vehicle to the wireless charging pad relative to the transmitters 34 are set forth. In step 1110, the vehicle operator sets the predetermined position as the charging pad of interest.

In step 1112, the distance between the vehicle and the transmitter (which corresponds to the wireless charging pad position and the predetermined position) is determined. The position of the vehicle may be triangulated through the cellular system or may be provided through the GPS system 88 in a macro location determination. The transmitter position may be fixed and communicated to the vehicle through the network. The position of the transmitter may also be known by the vehicle.

In step 1114, when the distance between the vehicle and the transmitter is not less than a predetermined distance, step 1116 is performed. The predetermined distance corresponds to the distance of the boundary set forth by the distance operator from switching to a macro location to a micro location determination. The predetermined distance may therefore be referred to as macro/micro location boundary. When the vehicle is outside of the boundary or not less than the predetermined distance, step 1116 continues directing the vehicle toward or in alignment with the beacon using macro-location. After step 1116, step 1112 is again performed.

Referring back to step 1114, when the distance is less than the predetermined distance, the system uses micro location to direct the vehicle to the proper location. After step 1114, step 1118 generates a beacon initiation signal at one of the initiation controllers. That is, the beacon initiation signal activates the beacon to begin generating a signal. The beacon initiation signal may be generated from the vehicle, the central controller or at the beacon controller.

In step 1120, the beacon initiation signal is communicated to a beacon transmitter. When one or more beacon transmitters are used, a plurality of signals initiating the operation of the beacon transmitters will be performed. In step 1122, the beacon transmitter starts transmitting signal such as a continuous tone signal. In this example, a Bluetooth® continuous tone signal may be generated by each of the transmitters. In step 1124, a high accuracy distance measurement system, such as the distance determination controller 86 illustrated in FIG. 4, generates a distance to the transmitters 34 from the receivers 44. Based upon the distances between the various receivers and the various transmitters, triangulation techniques are used to determine the location of the vehicle relative to the transmitters and therefore relative to the charging pad, which is the predetermined location, since the position is fixed. The high accuracy micro-location distance measurement system guides the driver or the autonomous vehicle system to the correct position (the predetermined location) by traversing the desired direction. For an autonomous vehicle, the vehicle may operate the steering system and the braking system 74 to direct the vehicle into the desired location while controlling the speed by the speed controller 64A. A non-autonomous vehicle may provide the screen displays such as those illustrated in FIG. 10 to guide the vehicle operator to the desired location.

In step 1128, the vehicle detects whether the system is properly aligned with the wireless charging pad at the predetermined position. When the vehicle is aligned with the wireless charging pad, the vehicle is placed into a fixed or parked position in step 1130 to allow the vehicle to charge.

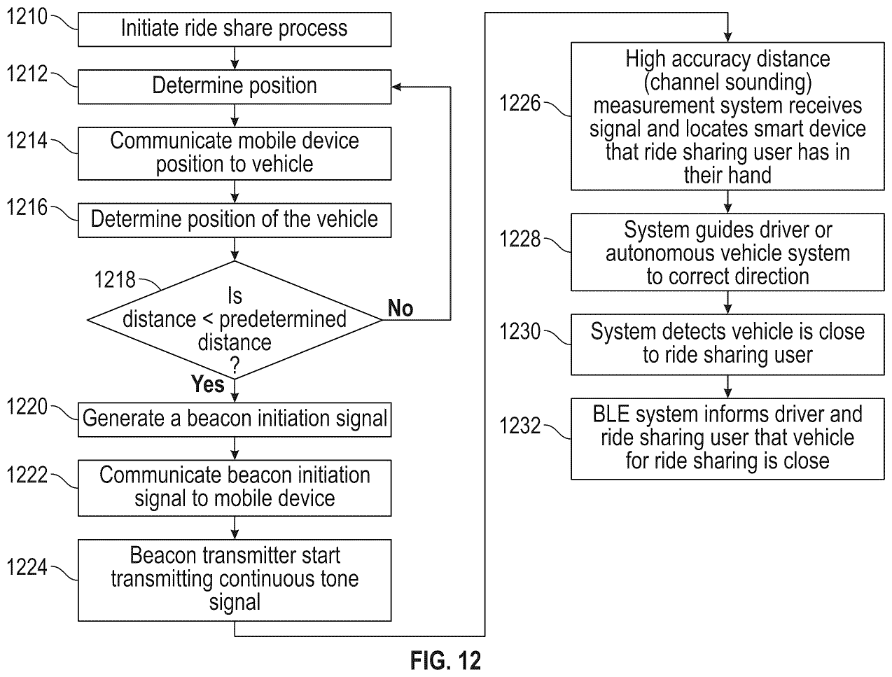

Referring now to FIG. 12, the ride share process is initiated in step 1210. The initiation of the ride share application may allow a predetermined location for the ride share vehicle to achieve to pick up a ride share requester. That is, the location of the mobile device may be determined by various techniques including triangulation based upon a cellular system or a GPS system. The position of the mobile device may be communicated to the vehicle 10 through the network 30 through the associated network interfaces. A central controller may act as communication means that controls the system and allows communication between the mobile device and the vehicle. In step 1212, the determination of the mobile device requesting a ride share is determined. In step 1214, the mobile device position is communicated to the receiver or receivers in the vehicle. In step 1216, the macro-location position of the vehicle is determined. The vehicle position (macro-location) may be determined by GPS or triangulation as mentioned above. In step 1218, it is determined whether the distance between the vehicle and the mobile device initiating the ride share request (the predetermined position) is less than a predetermined distance. When the distance is not less than a predetermined distance, the vehicle and the ride share user are outside of the boundary 40′ illustrated above. Therefore, after step 1218 indicates the distance is not less than a predetermined distance, step 1212 is performed. When the distance is less than a predetermined distance, the system indicates the vehicle is close or within the boundary 40′ so micro-location can be used. Thereafter, step 1220 generates a beacon initiation signal. The beacon initiation signal may be generated from the vehicle, the central controller or within the beacon controller. After step 1220, step 1222 communicates the beacon ignition signal to the mobile device. In step 1224, based upon the initiation signal, the beacon transmitters start to transmit a continuous tone signal that is received by the receiver. The beacon transmitter may be a Bluetooth continuous tone signal. After step 1224, step 1226 determines the distance between the transmitters and the various receivers as described in step 1124 above. This allows the ride sharing user to be located based upon the position of the mobile device which is presumably in the hands of the ride share requester, which is the predetermined position. In step 1228, the system guides the driver to the predetermined position through screen displays or the autonomous vehicle system into the correct direction. As mentioned above, displays may be generated to direct the vehicle to the predetermined location in a nonautonomous fashion. The autonomous vehicle may generate brake signals, steering signals, speed control signals and the like for directing the vehicle into the desired position. After step 1228, step 1230 detects when the vehicle is close to the ride sharing user or mobile device. In step 1232, the vehicle display may inform the driver that the ride sharing user is close to the vehicle. Likewise, an indicator on the screen display of the mobile device may generate an indication that the vehicle is close by.

The foregoing description is merely illustrative in nature and is in no way intended to limit the disclosure, its application, or uses. The broad teachings of the disclosure can be implemented in a variety of forms. Therefore, while this disclosure includes particular examples, the true scope of the disclosure should not be so limited since other modifications will become apparent upon a study of the drawings, the specification, and the following claims. It should be understood that one or more steps within a method may be executed in different order (or concurrently) without altering the principles of the present disclosure. Further, although each of the embodiments is described above as having certain features, any one or more of those features described with respect to any embodiment of the disclosure can be implemented in and/or combined with features of any of the other embodiments, even if that combination is not explicitly described. In other words, the described embodiments are not mutually exclusive, and permutations of one or more embodiments with one another remain within the scope of this disclosure.

Spatial and functional relationships between elements (for example, between modules) are described using various terms, including “connected,” “engaged,” “interfaced,” and “coupled.” Unless explicitly described as being “direct,” when a relationship between first and second elements is described in the above disclosure, that relationship encompasses a direct relationship where no other intervening elements are present between the first and second elements, and also an indirect relationship where one or more intervening elements are present (either spatially or functionally) between the first and second elements.

As used herein, the phrase at least one of A, B, and C should be construed to mean a logical (A OR B OR C), using a non-exclusive logical OR. For example, the phrase at least one of A, B, and C should be construed to include any one of: (i) A alone; (ii) B alone; (iii) C alone; (iv) A and B together; (v) A and C together; (vi) B and C together; (vii) A, B, and C together. The phrase at least one of A, B, and C should not be construed to mean “at least one of A, at least one of B, and at least one of C.”

In the figures, the direction of an arrow, as indicated by the arrowhead, generally demonstrates the flow of information (such as data or instructions) that is of interest to the illustration. For example, when element A and element B exchange a variety of information, but information transmitted from element A to element B is relevant to the illustration, the arrow may point from element A to element B. This unidirectional arrow does not imply that no other information is transmitted from element B to element A. Further, for information sent from element A to element B, element B may send requests for, or receipt acknowledgements of, the information to element A. The term subset does not necessarily require a proper subset. In other words, a first subset of a first set may be coextensive with (equal to) the first set.

In this application, including the definitions below, the term “module” or the term “controller” may be replaced with the term “circuit.” The term “module” or the term “controller” may refer to, be part of, or include processor hardware (shared, dedicated, or group) that executes code and memory hardware (shared, dedicated, or group) that stores code executed by the processor hardware.

The module or controller may include one or more interface circuits. In some examples, the interface circuit(s) may implement wired or wireless interfaces that connect to a local area network (LAN) or a wireless personal area network (WPAN). Examples of a LAN are Institute of Electrical and Electronics Engineers (IEEE) Standard 802.11-2016 (also known as the WIFI wireless networking standard) and IEEE Standard 802.3-2015 (also known as the ETHERNET wired networking standard). Examples of a WPAN are IEEE Standard 802.15.4 (including the ZIGBEE standard from the ZigBee Alliance) and, from the Bluetooth Special Interest Group (SIG), the BLUETOOTH wireless networking standard (including Core Specification versions 3.0, 4.0, 4.1, 4.2, 5.0, and 5.1 from the Bluetooth SIG).

The module or controller may communicate with other modules or controllers using the interface circuit(s). Although the module or controller may be depicted in the present disclosure as logically communicating directly with other modules or controllers, in various implementations the module or controller may actually communicate via a communications system. The communications system includes physical and/or virtual networking equipment such as hubs, switches, routers, and gateways. In some implementations, the communications system connects to or traverses a wide area network (WAN) such as the Internet. For example, the communications system may include multiple LANs connected to each other over the Internet or point-to-point leased lines using technologies including Multiprotocol Label Switching (MPLS) and virtual private networks (VPNs).

In various implementations, the functionality of the module or controller may be distributed among multiple modules that are connected via the communications system. For example, multiple modules may implement the same functionality distributed by a load balancing system. In a further example, the functionality of the module or controller may be split between a server (also known as remote, or cloud) module and a client (or, user) module. For example, the client module may include a native or web application executing on a client device and in network communication with the server module.

The term code, as used above, may include software, firmware, and/or microcode, and may refer to programs, routines, functions, classes, data structures, and/or objects. Shared processor hardware encompasses a single microprocessor that executes some or all code from multiple modules or controllers. Group processor hardware encompasses a microprocessor that, in combination with additional microprocessors, executes some or all code from one or more modules. References to multiple microprocessors encompass multiple microprocessors on discrete dies, multiple microprocessors on a single die, multiple cores of a single microprocessor, multiple threads of a single microprocessor, or a combination of the above.

Shared memory hardware encompasses a single memory device that stores some or all code from multiple modules. Group memory hardware encompasses a memory device that, in combination with other memory devices, stores some or all code from one or more modules.

The term memory hardware is a subset of the term computer-readable medium. The term computer-readable medium, as used herein, does not encompass transitory electrical or electromagnetic signals propagating through a medium (such as on a carrier wave); the term computer-readable medium is therefore considered tangible and non-transitory. Non-limiting examples of a non-transitory computer-readable medium are nonvolatile memory devices (such as a flash memory device, an erasable programmable read-only memory device, or a mask read-only memory device), volatile memory devices (such as a static random access memory device or a dynamic random access memory device), magnetic storage media (such as an analog or digital magnetic tape or a hard disk drive), and optical storage media (such as a CD, a DVD, or a Blu-ray Disc).

The apparatuses and methods described in this application may be partially or fully implemented by a special purpose computer created by configuring a general-purpose computer to execute one or more particular functions embodied in computer programs. The functional blocks and flowchart elements described above serve as software specifications, which can be translated into the computer programs by the routine work of a skilled technician or programmer.

The computer programs include processor-executable instructions that are stored on at least one non-transitory computer-readable medium. The computer programs may also include or rely on stored data. The computer programs may encompass a basic input/output system (BIOS) that interacts with hardware of the special purpose computer, device drivers that interact with particular devices of the special purpose computer, one or more operating systems, user applications, background services, background applications, etc.

The computer programs may include: (i) descriptive text to be parsed, such as HTML (hypertext markup language), XML (extensible markup language), or JSON (JavaScript Object Notation), (ii) assembly code, (iii) object code generated from source code by a compiler, (iv) source code for execution by an interpreter, (v) source code for compilation and execution by a just-in-time compiler, etc. As examples only, source code may be written using syntax from languages including C, C++, C#, Objective C, Swift, Haskell, Go, SQL, R, Lisp, Java®, Fortran, Perl, Pascal, Curl, OCaml, JavaScript®, HTML5 (Hypertext Markup Language 5th revision), Ada, ASP (Active Server Pages), PHP (PHP: Hypertext Preprocessor), Scala, Eiffel, Smalltalk, Erlang, Ruby, Flash®, Visual Basic®, Lua, MATLAB, SIMULINK, and Python®.

Example embodiments are provided so that this disclosure will be thorough and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

What is claimed is:

1. A method comprising:
determining a first distance between a beacon transmitter and a vehicle;
when the first distance is less than a distance threshold, communicating an initiation signal to the beacon transmitter;
generating a beacon signal at the beacon transmitter in response to the initiation signal;
receiving the beacon signal at a receiver; and
generating a direction signal in a controller of the vehicle to achieve a predetermined position relative to the beacon transmitter based on the beacon signal.

2. The method of claim 1 wherein determining the first distance comprises determining a first location of the transmitter and a second location of the receiver, said first distance based on the first location and the second location.

3. The method of claim 1 wherein generating the beacon signal comprises generating a Bluetooth® continuous tone signal.

4. The method of claim 1 wherein generating the beacon signal comprises generating the beacon signal at the beacon transmitter coupled to a wireless charging pad.

5. The method of claim 1 wherein generating the beacon signal comprises generating a plurality of beacon signals at a plurality of beacon transmitters disposed around a wireless charging pad.

6. The method of claim 5 wherein receiving the beacon signal at the receiver comprises receiving the plurality of beacon signals at a plurality of spaced apart receivers disposed within the vehicle to form a plurality of received signals.

7. The method of claim 6 further comprising determining distances between the plurality of spaced apart receivers and the plurality of beacon transmitters based on the plurality of received signals.

8. The method of claim 7 further comprising determining a location of the vehicle based on the distances.

9. The method of claim 5 further comprising controlling the vehicle autonomously toward the wireless charging pad.

10. The method of claim 1 further comprising, in response to the direction signal, generating control commands to an autonomous vehicle system and controlling a vehicle direction based on the control commands toward the beacon transmitter.

11. The method of claim 1 further comprising, in response to the direction signal, generating a direction indicating screen display, generating an audible direction signal, or both.

12. The method of claim 1 wherein generating the beacon signal comprises generating the beacon signal from the beacon transmitter disposed in a mobile device.

13. The method of claim 1 wherein when the first distance is not less than a distance threshold, macro-locating the vehicle.

14. A system comprising:
a beacon transmitter;
a vehicle comprising a receiver;
a controller coupled to the receiver and determining a first distance between a beacon transmitter and the vehicle, and, when the first distance is less than a distance threshold, communicating an initiation signal to the beacon transmitter,
said beacon transmitter generating a beacon signal in response to the initiation signal;
said receiver receiving the beacon signal; and
said controller generating a direction signal to achieve a predetermined position relative to the beacon transmitter.

15. The system of claim 14 wherein the controller determining the first distance comprises the controller determining a first location of the transmitter and a second location of the receiver, said first distance based on the first location and the second location.

16. The system of claim 14 wherein the beacon transmitter is coupled to a wireless charging pad or disposed in a mobile device.

17. The system of claim 14 wherein the controller macro-locates the vehicle when the first distance is not less than a distance threshold.

18. The system of claim 14 wherein the beacon transmitter comprises a plurality of beacon transmitters disposed around a wireless charging pad, said beacon signal comprises a plurality of beacon signals, wherein the receiver comprises a plurality of spaced apart receivers disposed within the vehicle to form a plurality of received signals, said controller determining distances between the plurality of mobile receivers and the plurality of beacon transmitters based on the plurality of received signals and determining a location of the vehicle based on the distances.

19. The system of claim 14 wherein the controller generates control commands to an autonomous vehicle system based on the direction signal and controls a vehicle direction based on the control commands toward the beacon transmitter.

20. The system of claim 14 wherein the controller generates a direction indicating screen display, an audible direction signal, or both based on the direction signal.
